(19) United States
(12) Patent Application Publication
(10) Pub. No.: US 2025/0182221 A1
(43) Pub. Date: Jun. 5, 2025

(54) SYSTEM AND METHOD FOR VERSATILE TRAVEL BOOKING AND TRAVEL DATA MANAGEMENT

(71) Applicant: AMERICAN EXPRESS TRAVEL RELATED SERVICES COMPANY, INC., New York, NY (US)

(72) Inventors: Fraser George STEWART, Burgess Hil (GB); Robert David James TRAFFORD, Burgess Hil (GB)

(73) Assignee: AMERICAN EXPRESS TRAVEL RELATED SERVICES COMPANY, INC., New York, NY (US)

(21) Appl. No.: 18/526,502

(22) Filed: Dec. 1, 2023

(51) Int. Cl. G06Q 50/14; G06Q 10/02

(52) U.S. Cl. CPC G06Q 50/14; G06Q 10/02

(57) ABSTRACT

Disclosed herein are system, method, and computer program product embodiments for providing improved travel searching and data management. Rather than searching through one or more intermediary aggregators, a travel data management system communicates directly with suppliers or other inventory managers. A plurality of routing rules can be applied at the front-end in order to determine particular suppliers to which the request should be routed. This can be based on user preferences, past user behavior, current supplier offers and deals, and other information. Once a supplier has been identified from this information, the request is routed accordingly. A response includes a plurality of search results that can be viewed and selected by the customer. Once a selection is made, and the reservation confirmed, the booking is automatically added to an itinerary data structure associated with the customer that can be updated and/or revised based on future changes.

### BACKGROUND

### Field

This field is generally related to travel booking, and more specifically to allowing for a versatile and efficient travel booking mechanism.

### Background

Currently, benefits providers are extremely limited in their abilities to seek out booking rates for their customers. Typically, those companies are limited to relying on a third-party aggregator to obtain booking options and pricing for the customer. This leads to inefficiencies in the amount of time required to perform bookings as well as inefficient messaging exchanges between server systems. Further, there is a lack of management across multiple booking sources which may require a user to maintain bookings on multiple systems.

### BRIEF SUMMARY

Disclosed herein are system, apparatus, device, method and/or computer program product embodiments, and/or combinations and sub-combinations thereof, for providing and automating versatile travel booking options.

A travel data management system and/or a travel networking system that receives requests from users, and can route them through multiple different channels to multiple different travel provider systems is described herein. An intermediary company, such as a benefits provider, may use the travel data management system to facilitate travel scheduling and/or itinerary generation across multiple travel supplier systems. The travel data management system includes multiple different connectors for connecting to different travel search engines and/or providers. For example, the system may connect to one or more Global Distribution Systems (GDSs), one or more New Distribution Capability (NDC) systems, as well as other providers.

Booking information from these different supplier systems is provided directly to the travel data management system associated with the intermediary company. Using a communication interface associated with the intermediary, the customer is able to navigate the different results in order to select and construct their booking. The resultant selections are then provided to the travel data management system, where they are added to the customer's itinerary. Rather than a customer manually adding different bookings to an account, the travel data management system manages a uniform itinerary that includes booking information received from different and/or disparate travel supplier systems. This may be an automated process as the travel data management system interfaces with different travel supplier systems. The itinerary generated and/or managed by travel data management system can be edited and updated at will to allow the user to maintain a single congruent itinerary.

In this manner, the travel data management system may provide a streamlined and efficient system for interfacing with multiple travel supplier systems and/or travel aggregator systems. This may provide an efficient process for electronic itinerary generation by providing access to and management of travel data from different supplier systems. Additionally, via the use of the travel data management system, more travel options become available to the customer, better prices can be negotiated directly by the intermediary company, and itineraries become more flexibly generated and/or updated. These and other advantages will be apparent from the following detailed description.

### BRIEF DESCRIPTION OF THE DRAWINGS

The accompanying drawings are incorporated herein and form a part of the specification.

FIG. 1 illustrates a block diagram of a travel searching environment, according to some embodiments.

FIG. 2 illustrates a block diagram of an exemplary searching environment, according to some embodiments.

FIG. 3A illustrates a block diagram of an exemplary travel data management system, according to some embodiments.

FIG. 3B illustrates a block diagram of an exemplary itinerary data structure, according to some embodiments.

FIG. 4 illustrates a process flow diagram of an exemplary method for travel searching and itinerary data structure updating, according to some embodiments.

FIG. 5 illustrates a flowchart diagram of an exemplary method for travel searching according to some embodiments.

FIG. 6 illustrates a block diagram of an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof, for diversifying and streamlining travel booking.

Intermediary companies, such as a credit card company or other benefits provider that may offer travel booking through one or more benefits, perks, points programs, etc. may be limited in the way that they provided travel booking services to their customers. Typically, this would include providing a mere pass-through to a travel booking aggregator. Although an interface to the customer could be made to look as though it belonged to the intermediary, the services may have been provided by the aggregator or travel provider. Due to the lack control over the services being provided, intermediary systems were limited in their ability to customize the customer's interface experience, provide different rates than those available elsewhere, or to assist the customer with itinerary generation. The travel booking system of the present application addresses these deficiencies of the prior art.

According to embodiments of this disclosure, a travel data management system and/or a travel networking system that receives requests from users, and can route them through multiple different channels to multiple different travel provider systems. An intermediary company, such as a benefits provider, may use the travel data management system to facilitate travel scheduling and/or itinerary generation across multiple travel supplier systems. The travel data management system includes multiple different connectors for connecting to different travel search engines and/or providers. For example, the system may connect to one or more Global Distribution Systems (GDSs), one or more New Distribution Capability (NDC) systems, as well as other providers.

Booking information from these different supplier systems is provided directly to the travel data management system associated with the intermediary company. Using a communication interface associated with the intermediary, the customer is able to navigate the different results in order to select and construct their booking. The resultant selections are then provided to the travel data management system, where they are added to the customer's itinerary. Rather than a customer manually adding different bookings to an account, travel data management system manages a uniform itinerary that includes booking information received from different and/or disparate travel supplier systems. Under previous configurations, it was not possible to add to a customer's itinerary. Rather, when the customer sought to add details to their itinerary, they would make a new booking, and this would result in a new itinerary. However, under the new configuration of this application, the itinerary is managed by the intermediary travel data management system. This may be an automated process as the travel data management system interfaces with different travel supplier systems. The itinerary generated and/or managed by the travel data management system can be edited and updated at will to allow the user to maintain a single congruent itinerary.

In this manner, the travel data management system may provide a streamlined and efficient system for interfacing with multiple travel supplier systems and/or travel aggregator systems. This may provide an efficient process for electronic itinerary generation by providing access to and management of travel data from different supplier systems. Additionally, via the use of the travel data management system, more travel options become available to the customer, better prices can be negotiated directly by the intermediary company, and itineraries become more flexibly generated and/or updated. These and other advantages will be apparent from the following detailed description.

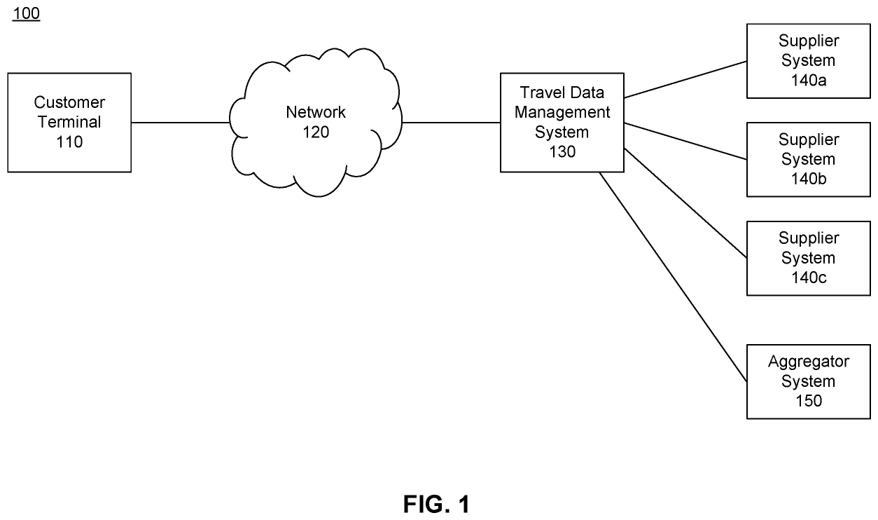

FIG. 1 illustrates a block diagram of a travel searching environment 100, according to some embodiments. As shown in FIG. 1, the environment 100 a customer terminal 110 connected to a travel data management system 130 via a network 120. The travel data management system 130 communicates with one or more supplier systems 140 and/or aggregator systems 150. Supplier systems 140 may correspond to supplier sever systems accessed via an API. Aggregator systems 150 may correspond to aggregator server systems accessed via an API.

In an embodiment, the customer terminal 110 may be a customer device, such as a computer, a smartphone, a tablet computer, a personal digital assistant, a telephone, or another device. The customer terminal 110 uses their device to gain access to the travel data management system 130 via the network. In an embodiment, the network 120 is any known communication network, including but not to one or more cellular telephone networks, such as 5G, 4G, etc., one or more packet-based networks, such as the Internet or VoIP, a plain old telephone (POTS) network, etc. Regardless of the particular network 120 employed, the customer terminal 110 is able to transmit a booking request to the travel data management system 130 via the network.

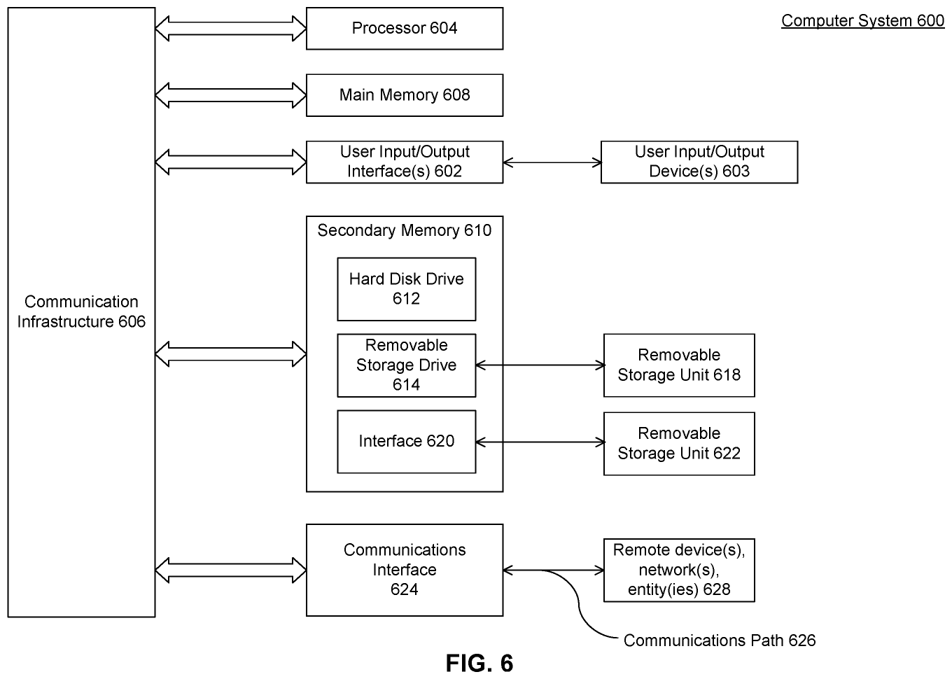

Then network 120 routes the request message to the travel data management system 130. In an embodiment, the request message is routed through an interface associated with the travel data management system 130. For example, in one embodiment, the customer terminal 110 may access a website associated with the intermediary company that hosts the travel data management system 130. Travel data management 130 may be interface with the website and/or host the website. For example, travel data management system 130 may be implemented using one or more servers and/or computer system 600 as further described with reference to FIG. 6. Travel data management system 130 may provide an interface over the network 120. The interface provides a mechanism for the customer terminal 110 to input search queries, review travel options, and/or book one or more travel components. In this example, the interface is provided within the website. In another example, the customer terminal 110 may access the travel data management system 130 via an app operating on a smartphone.

Through the interface, the customer terminal 110 may input one or more search criteria or submit a search request to the travel data management system 130. The travel data management system 130 receives the request and communicates with a variety of different travel searchers for responsive travel options that meet the user's request. In embodiments, the travel searchers may include one or more supplier systems 140 and/or aggregator systems 150, etc. In embodiments, aggregator systems 150 search a wide variety of supplier systems 140 for travel options, whereas supplier systems 140 provide the travel options directly. Under different circumstances, the travel data management system 130 may choose to search fewer than all available supplier systems 140 and/or aggregator systems 150 to meet the user's request.

The results of the search are provided back to the travel data management system 130, which packages the results for providing to the customer terminal 110 in the interface. Upon selection of one of the options by the user of customer terminal 110, the travel data management system 130 confirms the selected option with the relevant supplier system 140/aggregator system 150 and receives a booking confirmation therefrom, at which point the booking is added to the customer's itinerary, which is stored at the travel data management system 130. This may include modifying an itinerary data structure to include data retrieved from the supplier systems 140 and/or aggregator 150 systems. These and other aspects will be described in further detail below.

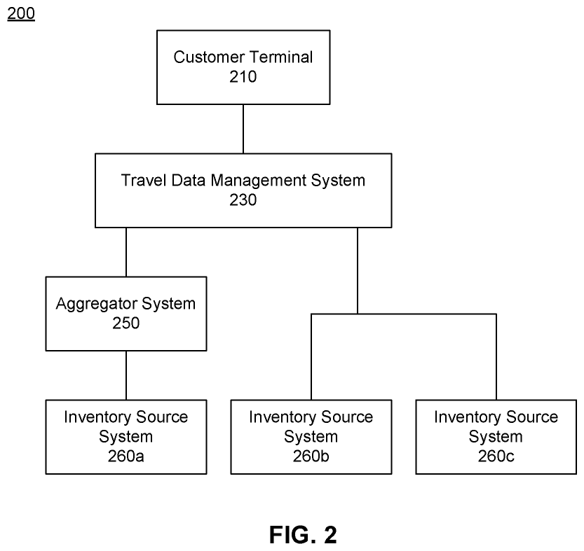

FIG. 2 illustrates a block diagram of an exemplary searching environment 200, according to some embodiments. As shown in FIG. 2, the searching environment 200 includes a customer terminal 210, travel data management system 230, aggregator system 250, and a plurality of inventory source systems 260a, 260b and 260c.

In the environment 200, a customer terminal 210 connects with the travel data management system 230 over any suitable communication interface. In embodiments, the communication interface may include any number of available networks using any known communication standards. Once in communication with the travel data management system 230, the customer terminal 210 may submit a search query or search request for specific travel information. In embodiments, this search query may relate to one or more of flights, hotels, ground transportation, tours, events, restaurants, etc.

In response to the search query, the travel data management system 230 has multiple different avenues for obtaining search results. A first avenue consists of the travel data management system 230 forwarding the search query to an aggregator system 250. The aggregator system 250 may be any of a variety of different travel aggregation providers, such as Sabre, Expedia, etc. The aggregator system 250 communicates with one or more inventory source systems 260a. In embodiments, the inventory source systems 260a may include direct connections with travel service providers, such as airlines, hotel chains, restaurants, or other accommodation providers. The aggregator system 250 identifies information relevant to the user's search query, and collects and organizes this relevant data for providing to the user.

The information obtained by the aggregator system 250 is provide to the travel data management system 230, which provides it to the customer terminal 210 via an interface. The travel data management system 230 may be operated by a credit card company, benefits provider, or other intermediary. However, because the intermediary that operates the travel data management system 230 goes through a third-party aggregator system 250 in order to obtain travel options, the intermediary is not able to negotiate prices directly with the inventory source systems 260a or suppliers, and also is restricted to the mechanism used by the aggregator system 250.

For example, traditional aggregator systems 250, such as Sabre, use a one-to-one relationship between a request and a booking. This is due primarily to the use of PNRs (personal notification records) that are currently used by these aggregator systems 250 (also referred to as Global Distribution Systems). In other words, when a user of customer terminal 210 requests to book a hotel and goes through the process to do so, an individual booking is generated for the hotel room. This booking cannot be added to an earlier booking, and cannot be modified at a later time with additional travel information. This results in a very disjointed travel plan, with all different aspects of a single trip having their own individual bookings.

Therefore, the travel data management system 230 of FIG. 2 has a second avenue, where the travel data management system 230 contacts inventory source systems 260b and 260c directly. The travel data management system 230 forwards the search query of the user to the inventory source systems 260b and 260c, and obtains relevant results in response thereto. The user may use customer terminal 210 to browse and/or select relevant search results. The customer terminal 210 can perform any number of searches and selections in this manner, and the travel data management system 230 will add those reservations to an itinerary data structure corresponding to an overall booking associated with the user using customer terminal 210. In embodiments, the travel data management system 230 can also add certain results to an “interested” listing associated with the user so that the user can return at a later time and quickly and easily relocate previous search results. In an embodiment, these “interested” listings may be saved for a certain period of time at the price originally returned before being reset or removed from the list.

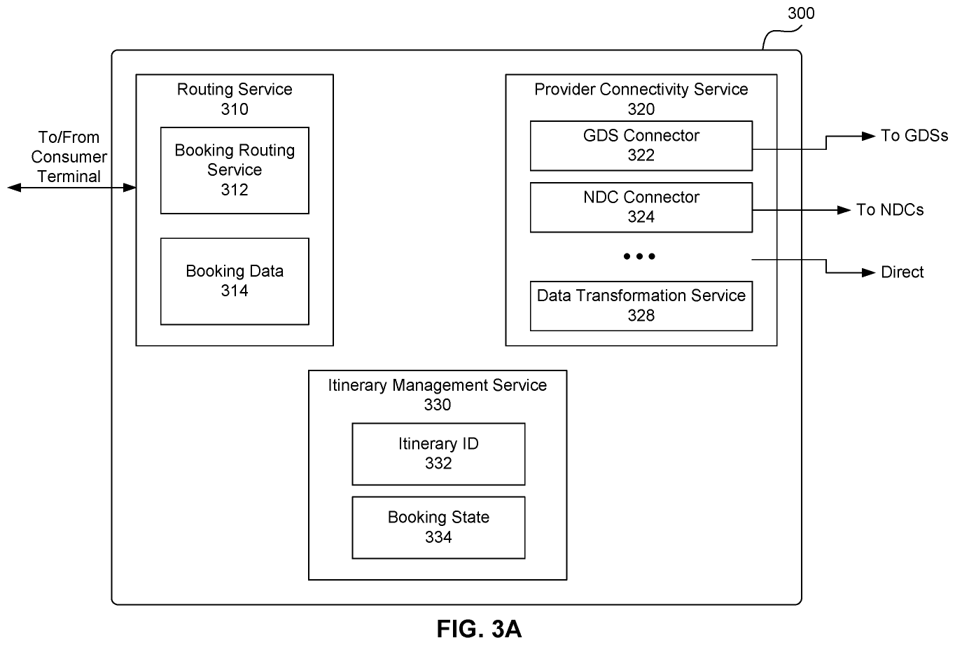

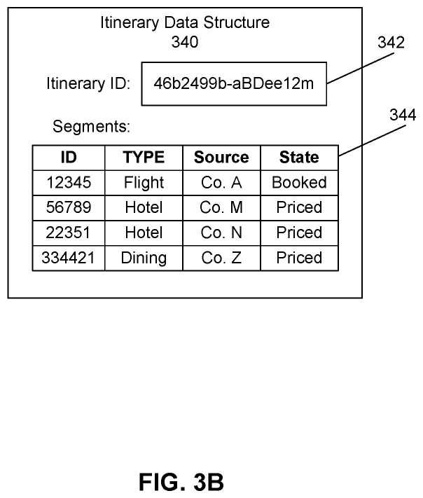

FIG. 3A illustrates a block diagram of an exemplary travel data management system 300, according to some embodiments. As shown in FIG. 3A, the travel data management system 300 includes a routing service 310, a provider connectivity service 320, and an itinerary management service 330. Although not explicitly illustrated in FIG. 3A, it should be understood that each of the different services 310, 320, and 330 may be controlled by, and the functions performed therein may be carried out by, one or more hardware processors.

As shown in FIG. 3A, a customer request may be received by the routing service 310 via a communication interface. In embodiments, the request may be provided through a web interface, such as a website, or through another means, such as a call with an agent. The request is received at the routing service 310. Booking routing service 312 routes the search information to the available providers by forwarding the request to the provider connectivity service 320.

The provider connectivity service 320 includes a Global Distribution System (GDS) connector 322, a New Distribution Capability (NDC) connector 324, and a data transformation service 328. In embodiments, the GDS connector 322 is configured to connect to Global Distribution System travel providers, such as any number of aggregators or other providers, such as Sabre, Amadeus, or Travelport. The NDC connector, on the other hand, connects to NDC-based travel providers. NDC may differ from GDS in that NDC may offer more tailored, lower fares. For example, a GDS may not have access to such options. Similarly, NDC may not have associated distribution surcharges. NDC may also provide pricing that can be personalized to the booker. Examples of NDCs may include United Airlines, Southwest Airlines, Hilton Hotels, etc. One or more additional connectors (not shown) may be used for connecting directly to other providers, such as Expedia, Booking.com, Resy Dining, Experiences, etc.

In embodiments, the provider connectivity service 320 can route requests to different providers based on a number of different factors. In an embodiment, requests are routed based on a destination profile. For example, certain suppliers may be stronger in particular markets than other suppliers. For example, Expedia may be strong in providing airline reservations, but Sabre may stronger with respect to hotels at least in terms of price and availability. Therefore, based on the type of request being made by the customer, the request can be routed accordingly.

In another embodiment, requests may be routed based on a user profile and/or customer profile. This may include the customer's preferences, loyalty and spend level, etc. In embodiments, this may be determined based on the customer creating a user profile with their preferences, or may alternatively be created by the system based on past user behavior. In an embodiment, machine learning can be used to refine the user's preferences over time based on their behavior. Certain loyalties may cause the provider connectivity service 320 to route to suppliers that have strong relationships with those providers, whereas higher spend levels may route to more luxury travel providers. A plurality of routing rules can be applied by travel data management system 300 in order to identify and determine particular supplier systems to which the request should be routed. This can be based on user preferences, past user behavior, current supplier offers and deals, and other information.

In another embodiment, the commercial interests of the consumer can be considered when routing the customer's request. For example, a customer may have a preferential or exclusive deal with a particular supplier. Once again, this can be manually provided by the customer, or can be learned by the travel data management system 300 based on the customer behavior. Requests would be routed based on this relationship.

In another embodiment, the customer's request can be routed based on commercial interests of the network. For example, the travel data management system 300 may prioritize a supplier based on a centralized deal, such as the supplier offering a large discount to the company hosting the travel data management system 300. In this case, requests may more often be routed to the supplier providing the discount.

In another embodiment, requests may be routed based on real-time availability of inventory. If one supplier is known to have more inventory relevant to the user's search, then the request will be routed preferentially to that supplier. In embodiments, this knowledge can be obtained based on previous results received from different suppliers. Notably, it will often be the case that multiple suppliers will have the same inventory. In this case, the request can be routed to the supplier with a fastest response time, or to one with a better track record of completing bookings. This, again, can be based on past responses from the different suppliers.

In another embodiment, routing can be performed based on a real-time pitch from a supplier. For example, when a request is made, different suppliers can pitch discounted rates depending on data in a user profile. This may be for a variety of reasons, such as merely trying to acquire business, Company A trying to poach Company B loyalists, etc. Based on the different pitches, the request can be routed accordingly. Therefore, if one supplier pitches a lower rate than another or pitches a certain discount over their lowest rate, then the request is routed to that supplier.

The above different routing options can be packed into a set of rules at the provider connectivity service 320. When a request is received, the provider connectivity service 320 analyzes the request against the set of rules in order to determine how to route the request to one or more of the available suppliers. This provides significant advantages over the current state of this field, where a single or a small number of aggregators are relied upon to acquire the full set of search results and the hosting company has no control or effect on the prices obtained or the suppliers selected.

Upon receipt of the search query, data transformation service 328 converts the request into one that can be read by the appropriate provider. For example, each of the GDS, NDC, and other providers listed above may use their own or different formats for a search query. The data transformation service 328 therefore converts the request into an appropriate format and then the respective connector 322/324, etc. sends the request to the provider.

Based on the search query, a response is received from the one or more providers responsive to the query. This information is received by the corresponding connector 322/324 and de-transformed by the data transformation service 328. The results are then provided back to the routing service 310 for providing to the customer through some interface, including a web interface, app interface, via an agent, etc. The customer is able to browse the different results to select one that is suitable to their preferences. Once a selection has been made by the customer, this selection is provided back to the provider connectivity service 320, which communicates with the provider that offered the selected reservation. The provider connectivity service 320 notifies the provider of the request to book the selected reservation, and receives a response from the provider that the reservation was booked (or not).

In response to receiving the booking confirmation, the data transformation service 328 transforms the response and forwards it to the routing service 310 and itinerary management service 330. The itinerary management service 330 includes an itinerary identification (ID) 332 that tracks an itinerary identifier associated with the customer's bookings. The itinerary management service 330 also manages booking states 334 corresponding to a particular itinerary data structure. As new bookings are added to the user's itinerary, the user's itinerary data structure is updated and the booking states 334 are associated with the itinerary ID 332. In an embodiment, the itinerary ID is a unique identification code to identify the itinerary and all bookings included within it. Meanwhile, the booking state 334 tracks the state of each booking in the itinerary data structure, including but not limited to “interested,” “confirmed,” “booked,” etc.

The itinerary management service 330 then notifies the routing service 310 of the change to the itinerary. The booking data 314 then notifies the user of the change to the itinerary, which may include confirming a booking, notifying an addition to the customer's itinerary, etc.

FIG. 3B illustrates a block diagram of an exemplary itinerary data structure 340, according to some embodiments. Itinerary data structure 340 may be a data structure managed by a travel data management system 300 as described with reference to FIG. 3A. Travel data management system 300 may maintain one or more itinerary data structures 340 for one or more users. Each itinerary data structure 340 may correspond to different a different trip or travel. Each trip may include several components, such as a travel component, a lodging component, a dining component, an activity component, and/or other reservation components. The itinerary data structure 340 may organize data received from different inventory source systems and/or supplier systems. This may include transforming and/or organizing disparate data formats to generate a uniform data storage scheme in the itinerary data structure 340. For example, this may utilize the data generated by data transformation service 328 following the receipt of travel and/or booking data from different supplier systems.

The itinerary data structure 340 corresponding to a particular trip may also include segments 344. The segments 344 may correspond to the different trip components previously described. Each segment 344 may include an identifier (ID), which may correspond to the particular booking and/or search result returned for a particular reservation. Each segment 344 may also include a type. The type designation may indicate the particular travel component for the segment data. Each segment 344 may also include source data. The source may identify the particular supplier system, aggregator system, and/or inventory source system providing a travel, booking, and/or pricing data. Each segment may also include a booking state. The booking state may correspond to booking state 334 as described with reference to FIG. 3A. The booking state may indicate a status corresponding to data organized in itinerary data structure 340.

For example, the booking state information may indicate that a particular travel component is booked. Data may be stored and/or metadata may provide this designation to be included in a particular user's itinerary. The booking state information may also include a priced status. This may indicate that search results have been returned with a particular associated pricing. The itinerary data structure 340 may store and/or preserve price information that was returned based on a search and/or query of inventory supplier systems. This may provide a uniform storage of pricing data from disparate inventory systems. A user may use travel data management system 300 to later accept the preserved pricing and/or to transmit a command to a supplier system to perform the booking. In some embodiments, the travel data management system 300 may also supply user data to the supplier system to perform the booking and/or reservation.

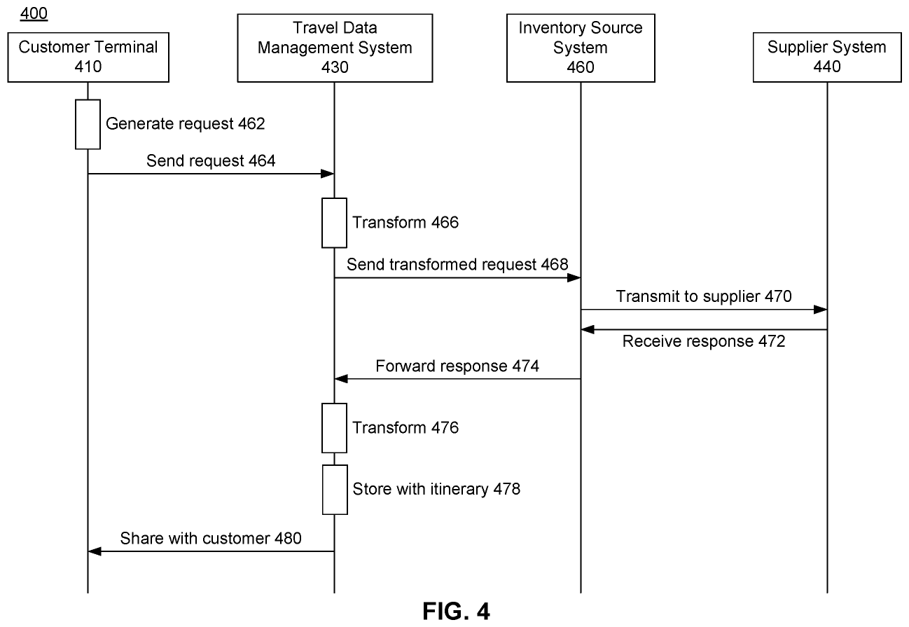

FIG. 4 illustrates a process flow diagram of an exemplary method for travel searching and itinerary data structure updating, according to some embodiments. As shown in FIG. 4, the process 400 occurs between a customer terminal 410, a travel data management system 430, inventory source system 460, and a supplier system 440. In embodiments, customer terminal 410 may represent an exemplary embodiment of customer terminal 110, travel data management system 430 may represent an exemplary embodiment of travel data management system 130, inventory source system 460 may represent an exemplary embodiment of inventory source systems 260, and supplier system 440 may represent an exemplary embodiment of supplier system 140.

As shown in FIG. 4, the process begins by the customer terminal 410 generating a request at 462. The customer terminal 410 transmits the request to the travel data management system 430 at 464. The travel data management system 430 transforms the request at 466, and then sends the transformed request to the inventory source system 460 at 468. Inventory source system 460 transmits the search request to a supplier system 440 at 470. In response, the supplier system 440 transmits a response message that includes the available reservations that meet the search criteria at 472. The inventory source system 460 forwards the response message to the travel data management system 430 at 474.

Upon receipt of the response message at the travel data management system 430, the travel data management system 430 transforms the received response back to a format usable by the travel data management system 430 at 476. The travel data management system 430 performs an inverse transformation (e.g., a de-transformation) of the received data at 476, and then stores the resultant information with the customer's itinerary at 478. Then the results are transmitted to and/or shared with the customer at 480.

The above steps 462-480 are then repeated for a booking request. Specifically, after browsing the search results, the customer terminal 410 submits a booking request at 462. This booking request is transformed and forwarded by the travel data management system 430, and a booking response is received from the supplier system 440 and inventory source system 460. The booking response is then reverse transformed at 476, added to the customer's itinerary data structure at 478, and shared with the customer at 480.

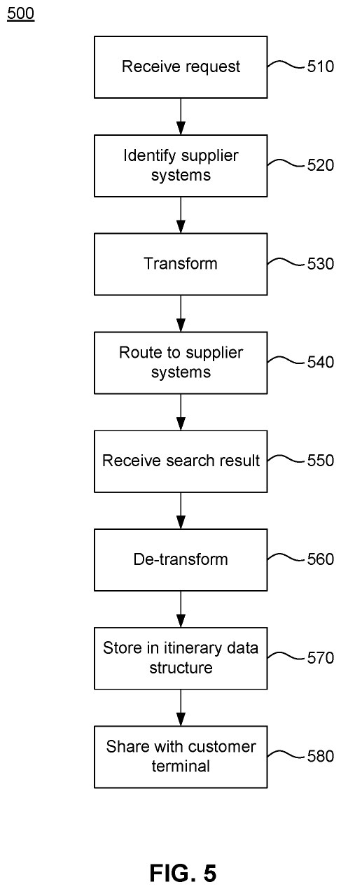

FIG. 5 illustrates a flowchart diagram of an exemplary method 500 for travel searching, according to some embodiments. Method 500 shall be described with reference to FIG. 1; however, method 500 is not limited to that example embodiment.

In an embodiment, travel data management system 130 may utilize method 500 to identify travel data or booking information and to automatically add this travel data to an itinerary data structure. The foregoing description will describe an embodiment of the execution of method 500 with respect to travel data management system 130. While method 500 is described with reference to travel data management system 130, method 500 may be executed on travel data management system 230, travel data management system 300, travel data management system 430, and/or any computing device, such as, for example, the computer system described with reference to FIG. 6 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

In step 510, travel data management system 130 receives a request from a customer terminal 110. In embodiments, the request is one of a search request or a booking request. The search request may include search criteria relating to travel accommodations.

In step 520, travel data management system 130 identifies one or more supplier systems 140 from among a plurality of supplier systems 140. Travel data management system 130 may perform this identification based on a plurality of routing rules, a user profile associated with the customer terminal 110, and/or the search criteria provided in the search request. For example, travel data management system 130 may identify one or more supplier systems 140 in the manner described with reference to FIG. 3A.

In step 530, travel data management system 130 transforms the request into a format that can be understood by one or more different supplier systems 140. In an embodiment, the transformation of the request includes transforming the request into multiple different query and/or data formats consistent with those used by different supplier systems 140. This allows the request to be understood and acted upon by those different supplier systems 140. Travel data management system 130 may transform the request into formats corresponding to the one or more supplier systems identified in step 520.

In step 540, travel data management system 130 routes the request to the supplier systems 140. For example, travel data management system 130 routes the request to the supplier systems 140 identified in step 520. In an embodiment, the request is submitted to multiple different supplier systems 140 directly. The supplier systems 140 may include and/or interface with inventory source systems 260, 460, such as those provided by Expedia, American Airlines, etc. Travel data management system 130 may also route requests to aggregator systems 150, such as Sabre. In some embodiments, travel data management system 130 may route the request to the supplier systems 140 via inventory source systems 260, 460 and/or aggregator systems 150, 250.

In step 550, travel data management system 130 receives a search result response from the supplier systems 140. In response to the request being a search request, travel data management system 130 receives a response message from the supplier systems 140 that includes the search results responsive to that request. For example, in response to a hotel search, the response includes hotel listing for the relevant dates, whereas a flight search would return flight options within or near the relevant time period. If the request is a booking request, then the response includes a confirmation as to whether the travel element was successfully booked.

In step 560, travel data management system 130 de-transforms the response message. In other words, the response is converted from a received format into a format useable by the searching engine and/or travel data management system, either for generating the display to the user, forwarding to the user, and/or storing in the user's itinerary data structure. In some embodiments, this may include performing an inverse transformation.

In step 570, travel data management system 130 stores the information included in the response message to the user's itinerary data structure. For example, travel data management system 130 may add search result data and/or a booking state identifier to the itinerary data structure. This may occur in the manner described with reference to FIG. 3B. In an embodiment, this storage occurs when the response message relates to a confirmed booking request. In some embodiments, travel data management system 130 may update a booking state identifier of an itinerary data structure to indicate the booking confirmation. For example, this may include a change from a “priced” booking state to a “booked” booking state. In some embodiments this step may be skipped when the response message is a set of search results relating to a search request by the customer terminal 110.

In step 580, travel data management system 130 shares the results of the response message with customer terminal 110. For example, once added to the user's itinerary, the results of the response message may be shared with the user. Travel data management system 130 may generate one or more graphical user interfaces (GUIs) and/or GUI data to be used to display the information. In an embodiment, travel data management system 130 transmits this GUI data to a customer terminal 110. The customer terminal 110 uses this GUI data to generate the GUIs and/or to display the results to the user in a display interface. When the results relate to the user's search request, then the search results are provided to the user in a manner that allows the user to peruse the results and select a preferred option for booking and/or save one or more of the results for later booking. When the results relate to a booking confirmation, then the results are provided to the user in any manner that allows the user to be informed of the confirmation.

In the manner described above, travel data management system 130 is able to not only communicate directly with various supplier systems 140 in order to obtain inventory at preferred prices, but can also update a customer's itinerary data structure with pending and confirmed bookings.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method for travel searching and data management, comprising:
receiving a search request from a customer terminal, the search request including search criteria relating to travel accommodations;
identifying a supplier system from among a plurality of supplier systems based on a plurality of routing rules, a user profile associated with the customer terminal, and the search criteria;
routing the request to the identified supplier system and to an aggregator system;
receiving a first search result from the identified supplier system and a second search result from the aggregator system; and
storing the received first and second search results in an itinerary data structure with a corresponding booking state identifier.

2. The method of claim 1, wherein the user profile includes an identification of customer loyalties and a plurality of customer preferences.

3. The method of claim 1, wherein the plurality of routing rules includes a strength of supplier rule that routes the request based on prices offered by the plurality of supplier systems or availability of inventory at the plurality of supplier systems.

4. The method of claim 1, wherein the plurality of routing rules includes a customer profile rule that routes the request based on customer preferences, customer loyalty, or customer spend level.

5. The method of claim 1, further comprising transforming the request into a format suitable for the supplier system prior to routing the request to the supplier system.

6. The method of claim 1, further comprising:
receiving a booking confirmation from the supplier system; and
de-transforming the booking confirmation.

7. The method of claim 6, further comprising:
updating the booking state identifier of the itinerary data structure to indicate the booking confirmation.

8. A system for travel searching and data management, comprising:
a communication interface configured to provide input and output with a customer terminal;
a memory that stores a user profile associated with a customer; and
one or more processors configured to:
receive a search request from the customer terminal via the communication interface, the search request including search criteria relating to travel accommodations;
identifying a supplier system from among a plurality of supplier systems based on a plurality of routing rules, the user profile, and the search criteria;
route the request to the identified supplier system and to an aggregator system;
receive a first search result from the identified supplier system and a second search result from the aggregator system; and
store, in the memory, the received first and second search results in an itinerary data structure with a corresponding booking state identifier.

9. The system of claim 8, wherein the user profile includes an identification of customer loyalties and a plurality of customer preferences.

10. The system of claim 8, wherein the plurality of routing rules includes a strength of supplier rule that routes the request based on prices offered by the plurality of supplier systems or availability of inventory at the plurality of supplier systems.

11. The system of claim 8, wherein the plurality of routing rules includes a customer profile rule that routes the request based on customer preferences, customer loyalty, or customer spend level.

12. The system of claim 8, wherein the one or more processors are further configured to transform the request into a format suitable for the supplier system prior to routing the request to the supplier system.

13. The system of claim 8, wherein the one or more processors are further configured to:
receive a booking confirmation from the supplier system; and
de-transform the booking confirmation.

14. The system of claim 13, wherein the one or more processors are further configured to:
update the booking state identifier of the itinerary data structure to indicate the booking confirmation.

15. A non-tangible computer-readable storage medium having instructions stored thereon that, when executed by one or more processors, cause the one or more processors to perform functions, comprising:
receiving a search request from a customer terminal, the search request including search criteria relating to travel accommodations;
identifying a supplier system from among a plurality of supplier systems based on a plurality of routing rules, a user profile associated with the customer terminal, and the search criteria;
routing the request to the identified supplier system and to an aggregator system;
receiving a first search result from the identified supplier system and a second search result from the aggregator system; and
storing the received first and second search results in an itinerary data structure with a corresponding booking state identifier.

16. The non-tangible computer-readable storage medium of claim 15, wherein the user profile includes an identification of customer loyalties and a plurality of customer preferences.

17. The non-tangible computer-readable storage medium of claim 15, wherein the plurality of routing rules includes a strength of supplier rule that routes the request based on prices offered by the plurality of supplier systems or availability of inventory at the plurality of supplier systems.

18. The non-tangible computer-readable storage medium of claim 15, wherein the plurality of routing rules includes a customer profile rule that routes the request based on customer preferences, customer loyalty, or customer spend level.

19. The non-tangible computer-readable storage medium of claim 15, the functions further comprising transforming the request into a format suitable for the supplier system prior to routing the request to the supplier system.

20. The non-tangible computer-readable storage medium of claim 15, the functions further comprising:
receiving a booking confirmation from the supplier;
de-transforming the booking confirmation; and
updating the booking state identifier of the itinerary data structure to indicate the booking confirmation.
